(19) United States
(12) Patent Application Publication
(10) Pub. No.: US 2006/0256375 A1
(43) Pub. Date: Nov. 16, 2006

(54) Image forming apparatus and method of controlling user interface of image forming apparatus

(76) Inventor: Yoshihiko Abe, Kawasaki city (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/432,488

(22) Filed: May 12, 2006

(30) Foreign Application Priority Data
May 12, 2005 (JP) 2005-139336

(51) Int. Cl. G06F 3/12

(52) U.S. Cl. 358/1.15

(57) ABSTRACT

An image forming apparatus for processing a document with document attribution information includes a controller and a display unit. The controller sets an image processing mode, which matches to the document attribution information of the document, when the document to be processed by the image forming apparatus is designated. The display unit displays the image processing mode as a screen view, by which an operator selects the image processing mode.

### BACKGROUND OF THE INVENTION

1. Field of the Invention

The present disclosure generally relates to an image forming apparatus, and more particularly to an image forming apparatus having a user interface for displaying an image processing mode.

2. Discussion of the Background

An image forming apparatus can operate in a number of image processing modes (e.g., copying), and each of the image processing modes further includes a number of functions. Therefore, a user needs to select a function from a number of modes or functions to execute a desired image processing operation.

Accordingly, the user may be unsure how to select modes or functions because the user may have little knowledge on how to select modes or functions on the image forming apparatus, and thereby such a user feels inconvenienced or frustrated when selecting modes or functions.

An image forming apparatus may employ an operation guide to reduce the above-mentioned inconvenience for the user. Such an operation guide may include a display screen, which shows information corresponding to operation modes that can be executed in the image forming apparatus.

However, the user may need to select an operation mode even in such an image forming apparatus, and thereby the user may feel inconvenienced or frustrated when having to select a desired function from a number of modes or functions.

### SUMMARY OF THE INVENTION

The present disclosure relates to an image forming apparatus for processing a document with document attribution information. The image forming apparatus includes a controller and a display unit. The controller sets an image processing mode, which matches to the document attribution information of the document, when the document to be processed by the image forming apparatus is designated. The display unit displays the image processing mode as a screen view, by which an operator selects the image processing mode.

The present disclosure also relates to a method of controlling a screen view of a display unit of an image forming apparatus for document processing. The method includes operations of a designating, an obtaining, a requesting, a judging, a setting, and a displaying. The designating designates a document. The obtaining obtains document attribution information of the document. The requesting requests an image processing mode matched to the document attribution information of the document. The judging judges the image processing mode matched to the document attribution information. The setting sets a screen view including the image processing mode. The displaying displays the screen view on the display unit.

The present disclosure also relates to a program including computer-readable instructions that, when executed by a computer of an image forming apparatus, instructs the image forming apparatus to carry out a method of controlling a screen view of a display unit of the image forming apparatus. The computer-readable instructions include operations of a designating, an obtaining, a requesting, a judging, a setting, and a displaying. The designating designates a document. The obtaining obtains document attribution information of the document. The requesting requests an image processing mode matched to the document attribution information of the document. The judging judges the image processing mode matched to the document attribution information. The setting sets a screen view including the image processing mode. The displaying displays the screen view on the display unit.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic block diagram of a network system connected to an image forming apparatus according to an example embodiment of the present invention;

FIG. 2 is a schematic block diagram showing a configuration of an image forming apparatus in FIG. 1;

FIG. 3 is a schematic view of an operation panel of an image forming apparatus in FIG. 1;

FIG. 4 is a schematic view of a screen view of an operation panel of an image forming apparatus, wherein FIG. 4 shows one default screen;

FIG. 5 is a schematic view of a screen view of an operation panel of an image forming apparatus, in which the screen view shows a copy mode for a classified document;

FIG. 6 is a schematic table having document attribution information, which is classified by document identification;

FIG. 7A is a schematic view of a screen view of an operation panel of an image forming apparatus, in which the screen view shows a copy mode when document sheets are more than four;

FIG. 7B is a schematic view of a screen view of an operation panel of an image forming apparatus, in which the screen view shows a copy mode for a color sheet;

FIG. 8A is a schematic table including recommended modes and priority levels;

FIG. 8B is a schematic view of a screen view of an operation panel of an image forming apparatus, in which the screen view shows a copy mode when document sheets are more than four and when a color sheet is used;

FIG. 9A is a schematic table including recommended modes and priority levels;

FIG. 9B is a schematic view of a screen view of an operation panel of an image forming apparatus, in which the screen view shows a copy mode when document sheets are more than four and when a color sheet is used;

FIGS. 10A to 10C are schematic views of screen views of an operation panel of an image forming apparatus, in which the screen views show a copy mode selecting image processing modes with a time-line;

FIG. 11A to 11C are schematic views of screen views of an operation panel of an image forming apparatus, in which the screen views show a copy mode selecting image processing modes with a predetermined order;

FIG. 12 is a schematic view of a screen view of an operation panel of an image forming apparatus, by which an operation type is selected;

FIG. 13 is a schematic table including image processing modes and user-specific priority levels;

FIG. 14 is a schematic configuration of an image forming apparatus FX shown in FIG. 1;

FIG. 15A is a schematic sequence chart for explaining a process for setting a recommended mode for an electronic document with an image forming apparatus;

FIG. 15B is a schematic sequence chart for explaining a process for setting a recommended mode for a sheet document with an image forming apparatus;

FIG. 15C is a schematic sequence chart for explaining a process for setting a recommended mode for a sheet document with the image forming apparatus, wherein document attribution information is obtained from a server;

FIG. 16 is a flow chart for explaining a process of selecting a recommended mode for a document in an image forming apparatus;

FIGS. 17A, 17B are a flow chart for explaining a process of determining a recommended mode;

FIG. 18 is an example flow chart for explaining a selection of a recommended mode for an electronic document in an image forming apparatus; and

FIG. 19 is an example flow chart for explaining a selection of a recommended mode for a sheet document in an image forming apparatus.

### DETAILED DESCRIPTION OF THE PREFERRED EMBODIMENTS

In describing example embodiments shown in the drawings, specific terminology is employed for the sake of clarity. However, the disclosure of the present invention is not intended to be limited to the specific terminology so selected and it is to be understood that each specific element includes all technical equivalents that operate in a similar manner.

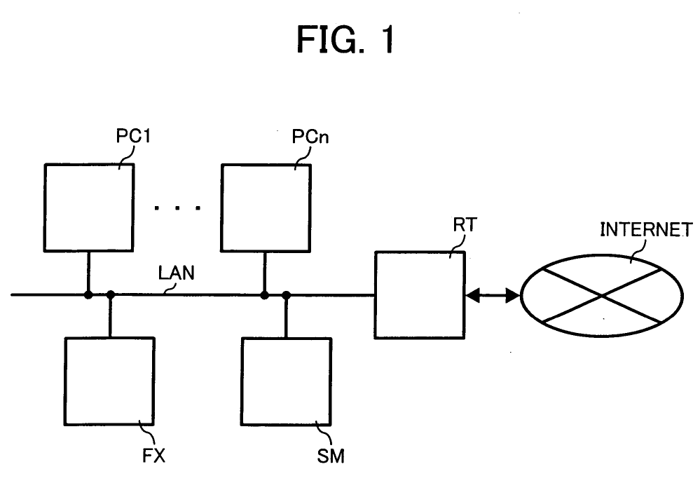

Referring now to the drawings, wherein like reference numerals designate identical or corresponding parts throughout the several views, an image forming apparatus according to an example embodiment is described with particular reference to FIGS. 1 to 3.

FIG. 1 is a block diagram of a network system including an image forming apparatus according to an example embodiment, wherein the image forming apparatus includes a copier, printer, facsimile, or a multi-functional apparatus that can conduct a plurality of functions such as copying, printing, and facsimile communication, for example.

As shown in FIG. 1, a plurality of terminal apparatuses are connected to a local area network (LAN), wherein the plurality of terminal apparatuses include personal computers PC1 to PCn, a server SM, and an image forming apparatus FX, for example. As also shown in FIG. 1, the LAN is connected to the Internet via a router RT.

Accordingly, the personal computers PC1 to PCn, server SM, and an image forming apparatus FX can communicate data with an external terminal apparatus via the Internet, as required.

The server SM can communicate with the personal computers PC1 to PCn and the image forming apparatus FX connected via the LAN. Such communication includes an electronic mail sending/receiving of the personal computers PC1 to PCn, and a notification of document attribution information to the image forming apparatus FX, for example.

For example, the document attribution information may be stored in a radio frequency identification chip (RFID chip) attached on a document sheet, wherein the RFID chip may include a wireless integrated circuit chip.

The personal computers PC1 to PCn can install a plurality of software programs such as facsimile application software for facsimile image processing, and communication software for data communication with other terminal apparatuses via the LAN, for example. Each of the personal computers PC1 to PCn can be used by one person or a plurality of persons, as required.

The image forming apparatus FX can execute a plurality of image processing modes such as copying, network printing, etc. and can communicate with other terminal apparatuses via the LAN. Similarly, the image forming apparatus FX can also communicate with an external terminal apparatus via the Internet.

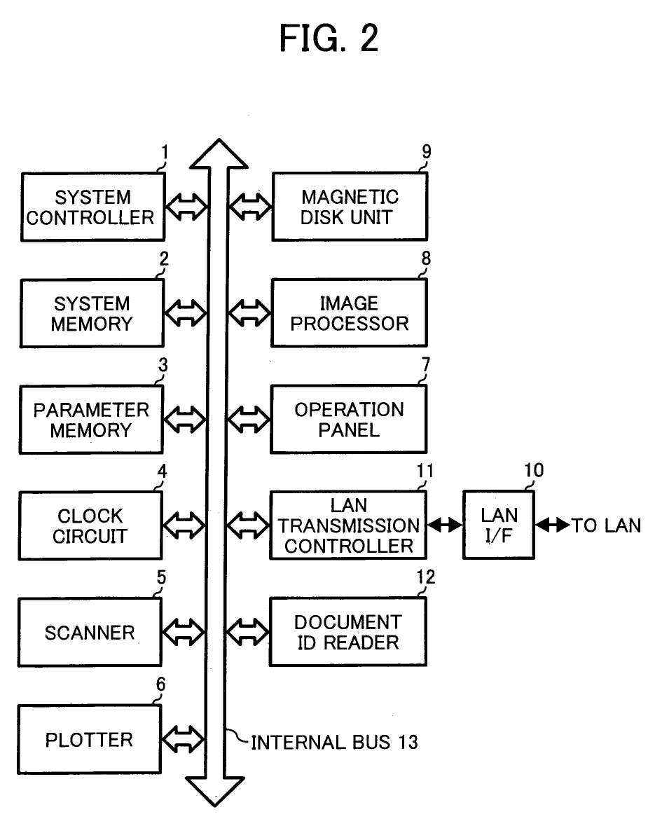

FIG. 2 is a block diagram showing a configuration of the image forming apparatus FX shown in FIG. 1.

As shown in FIG. 2, the image forming apparatus FX includes a system controller 1, a system memory 2, a parameter memory 3, a clock circuit 4, a scanner 5, a plotter 6, an operation panel 7, an image processor 8, a magnetic disk unit 9, a LAN interface circuit 10, a LAN transmission controller 11, and a document ID (identification) reader 12, which are all connected to each other via an internal bus 13, for example. The above-mentioned units in the image forming apparatus FX can communicate data with each other via the internal bus 13, for example.

The system controller 1 can conduct a plurality of control functions such as controlling each unit in the image forming apparatus FX and facsimile transmission, for example.

The system memory 2 can store data used for software programs run by the system controller 1, and can configure a working area for the system controller 1.

The parameter memory 3 can store information, which is prepared exclusively for the image forming apparatus FX. The clock circuit 4 can output present time information.

The scanner 5 can scan a document image such as a sheet document (e.g., paper) with a predetermined resolution, wherein such a document image includes a monochrome or color image.

The plotter 6 can produce an image with a predetermined resolution as a monochrome or color image on a recording medium such as a transfer sheet.

The operation panel 7 can include a plurality of operation keys and displays, wherein a user can use the operation panel 7 as a user interface unit to operate the image forming apparatus FX.

The image processor 8 can execute a plurality of image data processings such as image size changing, image concentration conversion, image compressing, and image extending, for example.

The magnetic disk unit 9 can store data such as scanned image data, image data acquired via the LAN, and file data of an application file, for example.

The LAN interface circuit 10 can connect the image forming apparatus FX to the LAN.

The LAN transmission controller 11 can control a transmission process between the terminal apparatuses via the LAN with a predetermined protocol suite for communicating data.

The document ID reader 12 can communicate data with a wireless IC (integrated circuit) chip, which may be attached on a document sheet. For example, the document ID reader 12 can read information from the wireless IC chip.

In an example embodiment, the above-mentioned terminal apparatuses, connected with each other via the LAN, can communicate data with each other with a protocol suite, which combines a transmission protocol and communication protocol. The transmission protocol includes, e.g., a TCP/IP (transmission control protocol/internet protocol) for a transport layer, and the communication protocol is provided on the transmission protocol as an upper layer. For example, a communication protocol such as SMTP (simple mail transfer protocol) can be used for communicating electronic mail data.

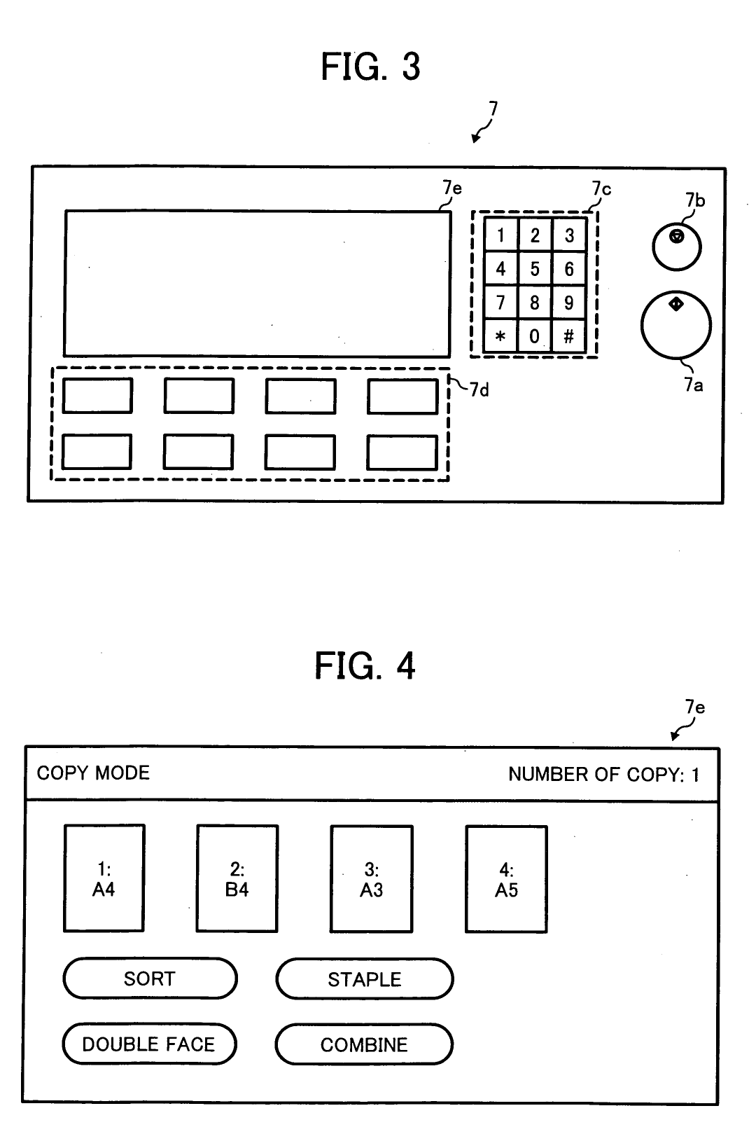

FIG. 3 is a schematic view of the operation panel 7 of the image forming apparatus FX.

The operation panel 7 includes a start key 7a, a stop key 7b, a numeric keypad 7c, a function key group 7d, and a touch panel 7e, as shown in FIG. 3.

A user can command a start operation to the image forming apparatus FX by pressing the start key 7a, and can command a stop operation to the image forming apparatus FX by pressing the stop key 7b. The user can input numeric information to the image forming apparatus FX with the numeric keypad 7c, wherein such numeric information may indicate a number of sheets for copying, for example. The function key group 7d includes a plurality of function keys, which are registered with a plurality of functions. Some of the function keys may be registered with functions specified by a system design of the image forming apparatus FX, and some of function keys may be registered with functions designated by the user.

The touch panel 7e can be made of a liquid crystal display (LCD), for example, which is to be touched by a user. The touch panel 7e can display a number of information such as sheet size/direction and event menu, for example. A user can select image processing conditions from the touch panel 7e.

Hereinafter, an example screen view of the touch panel 7e according to an example embodiment is explained with reference to FIG. 4.

The touch panel 7e displays a screen view shown in FIG. 4 as a default screen view for the image forming apparatus FX, for example.

When a user approaches the image forming apparatus FX with a document having a wireless IC chip thereon, for example, the document ID reader 12 detects the wireless IC chip on the document, communicates data with the wireless IC chip, and reads a document ID (identification) registered in the wireless IC chip. Then, a central processing unit (not shown) of the image forming apparatus FX checks whether document attribution information, corresponding to the document ID, is registered in the image forming apparatus FX.

The document attribution information defines a type of document based on a plurality of information. For example, the document attribution information includes a sheet size (e.g., A4 size), color of sheet (e.g., blue sheet), and document category (e.g., classified or not), for example.

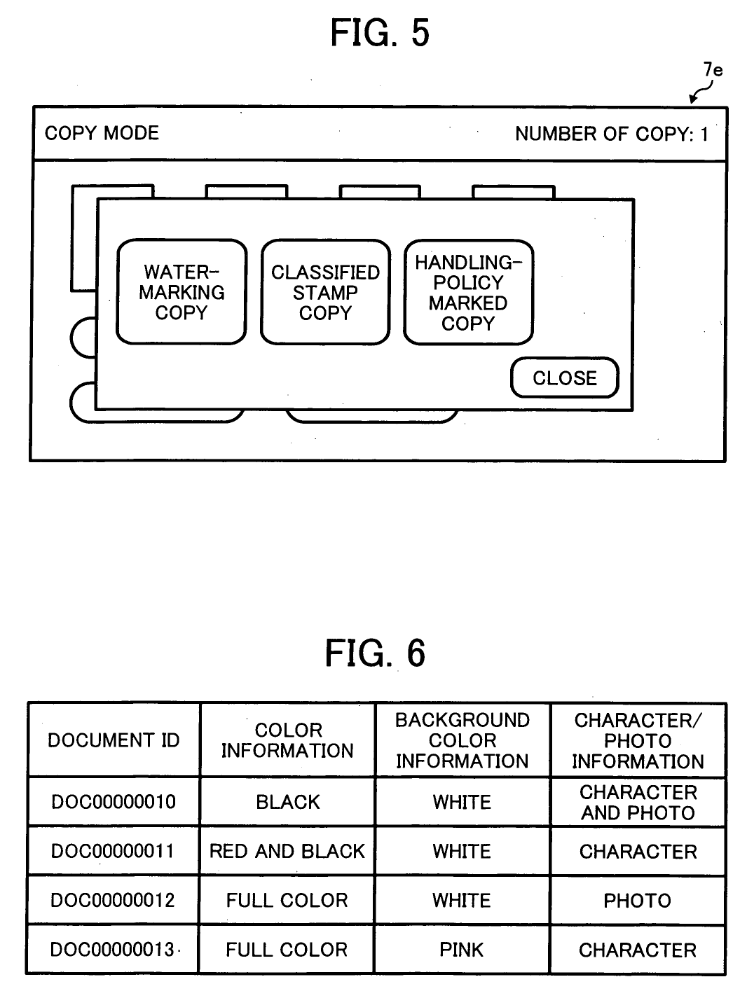

If the document attribution information is already registered in the image forming apparatus FX, another screen view is superimposed over the default screen view as shown in FIG. 5. For example, if the document attribution information includes a classified mark, a screen view for a classified document is superimposed over the default screen view as shown in FIG. 5. Such a screen view shows a copy mode for the classified document.

The screen view for a classified document shown in FIG. 5 includes as an example three buttons: a watermarking copy button; a classified stamp copy button; and a handling-policy marked copy button.

In the case of watermarking copy, a predetermined digital watermarking can be copied on a recording medium. In the case of classified stamp copy, an image of “classified stamp” can be copied on a recording medium. In the case of handling-policy marked copy, a guide message can be copied on a recording medium, wherein the guide message may say “This is a classified document which requires a care for handling,” for example.

The screen view shown in FIG. 5 also includes a “close” button, by which a user can select a copy mode, which does not conduct any one of the watermarking copy, classified stamp copy, and handling policy marked copy.

In addition to the document type information such as a classified mark, the document ID can include other information as shown in FIG. 6. For example, the document ID can include a plurality of document attribution information such as “color information,” “background color information,” and “character/photo information” as shown in FIG. 6.

The “color information” indicates the color used in the document image, the “background color information” indicates a background color of a document sheet, and the “character/photo information” includes character and photo information included in a document image.

FIG. 6 shows example document IDs and corresponding document attribution information.

A document ID “DOC00000010” registers black as color information, white as background color information, and character and photo as character/photo information.

A document ID “DOC00000011” registers red and black as color information, white as background color information, and character as character/photo information.

A document ID “DOC00000012” registers full color as color information, white as background color information, and photo as character/photo information.

A document ID “DOC00000013” registers full color as color information, pink as background color information, and character as character/photo information.

Such document IDs can be registered to image files (i.e., electronic documents) stored in the magnetic disk unit 9. For example, when an image file is stored in a document box in the magnetic disk unit 9, a document ID can be set for the image file. Such a document ID may include document attribution information such as a classified mark, for example.

When a user designates an image file in the document box as a to-be-printed document, the image forming apparatus FX obtains a document ID set for the designated image file, and checks the document attribution information corresponding to the document ID. If the document attribution information includes a classified mark, the touch panel 7e displays the screen view shown in FIG. 5.

When a classified document is to be copied, or when an image file specified as a classified document is to be retrieved from the document box for printing, the image forming apparatus FX can notify a user that a document to be processed is a classified document, and can show the appropriate screen view for a classified document (see FIG. 5) with the above-described method.

Accordingly, the user can recognize that a document to be handled is a classified document by viewing the touch panel 7e, and thereby the image forming apparatus FX can provide a user-friendly functionality such as easy-to-recognize types of documents.

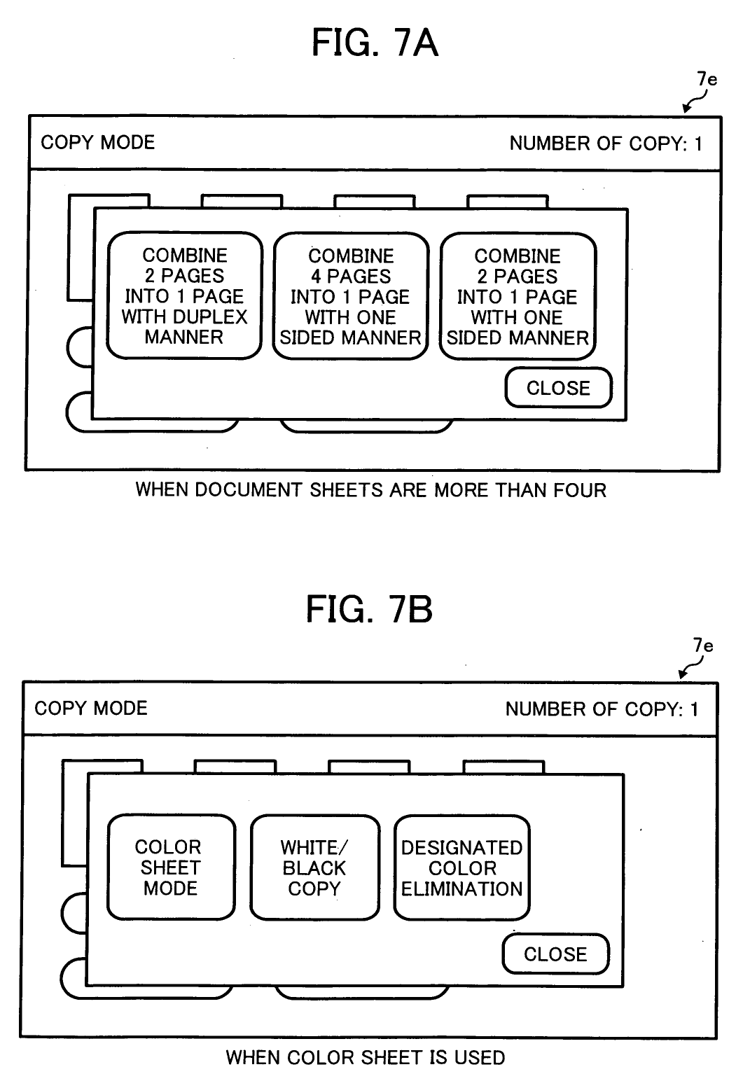

Hereinafter, another example screen view is explained with reference to FIGS. 7A and 7B.

When the scanner 5 scans a pile of document sheets, scanned image data is temporarily stored in the magnetic disk unit 9. The system controller 1 checks whether a number of document sheets scanned by the scanner 5 is more than four, for example. If the system controller 1 judges that the number of document sheets is more than four, the touch panel 7e displays a screen view shown in FIG. 7A.

Furthermore, the system controller 1 checks whether a background color of a scanned document sheet is non-white (i.e., color). For example, a document sheet may be a color sheet such as a blue sheet. If the system controller 1 judges that the background color of the scanned document sheet is a color sheet (e.g., blue sheet), the touch panel 7e displays a screen view shown in FIG. 7B.

The screen view shown in FIG. 7A includes as an example three buttons: a “combine 2 pages into 1 page with duplex manner” button; a “combine 2 pages into 1 page with one sided manner” button; and a “combine 4 pages into 1 page with one sided manner” button, wherein “combine” means a copy operation, which reduces a size of original pages to copy a plurality of original pages on one sheet.

In the case of “combine 2 pages into 1 page with duplex manner,” two pages are copied on one face of a sheet and another two pages are copied on the other face of the sheet, and thereby four pages can be copied on a same one sheet. In the case of “combine 2 pages into 1 page with one sided manner,” two pages are copied on one face of a sheet. In the case of “combine 4 pages into 1 page with one sided manner,” four pages are copied on one face of a sheet.

The screen view shown in FIG. 7A also includes a “close” button, by which a user can select a copy mode, which does not conduct any one of the “combine 2 pages into 1 page with duplex manner,” “combine 2 pages into 1 page with one sided manner,” and “combine 4 pages into 1 page with one sided manner.”

The screen view shown in FIG. 7B includes as an example three buttons: a “color sheet mode” button; a “white/black copy” button; and a “designated color elimination” button.

The color sheet mode is a mode to use a background color (=not white) of the color sheet as it is. The white/black copy is used to select the monochrome mode, which is used for making a white/black copy sheet from an original image on a color sheet. The designated color elimination can select a color to be eliminated from an original image on a color sheet.

Furthermore, the screen view shown in FIG. 7B also includes a “close” button, by which a user can select a copy mode, which does not conduct any one of the “color sheet mode,” “white/black copy,” and “designated color elimination.”

With such a control, the image forming apparatus FX can automatically notify appropriate image processing modes to a user, which may be suitable for a document to be processed.

Accordingly, the user can recognize what kind of image processing modes can be conducted by viewing the touch panel 7e, and thereby the image forming apparatus FX can provide a user-friendly functionality, such as time saving, for selecting image processing modes.

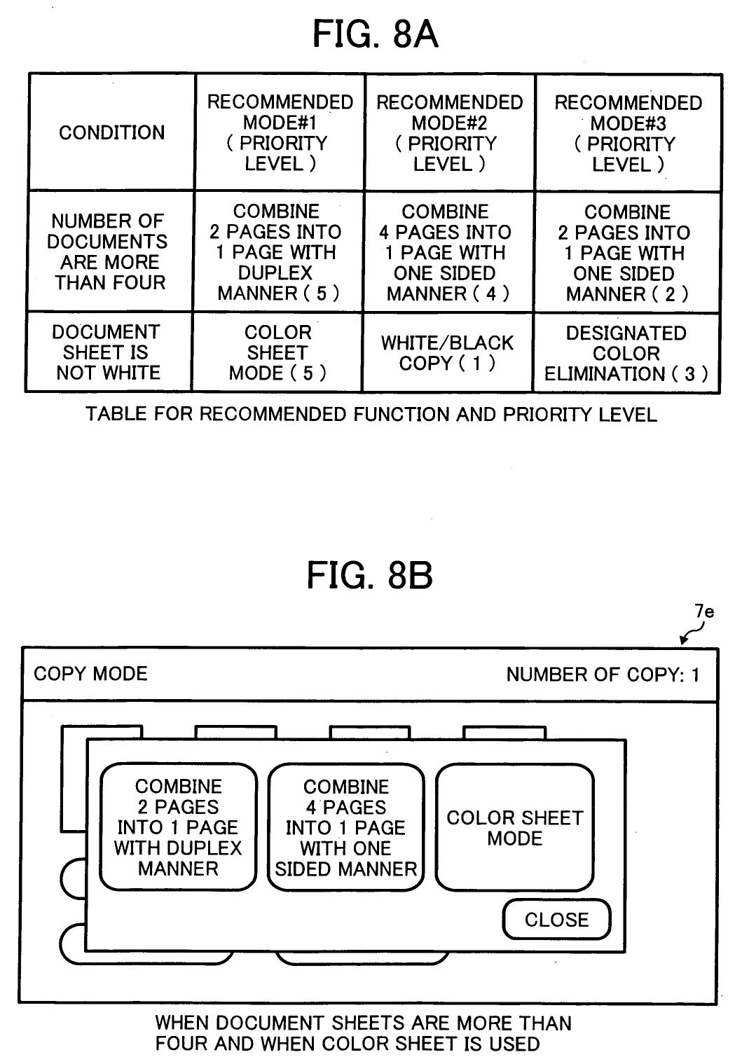

In one case, a user may want to copy a pile of documents using color sheets. In such a case, a table shown in FIG. 8A, which includes recommended modes and priority levels, may be stored in the image forming apparatus FX, and such a table can be used for setting a screen view for document processing.

The table shown in FIG. 8A, including recommended modes and priority levels, includes conditions such as “document number is more than four” and “document sheet is not white (e.g., blue sheet),” for example.

As for the condition of “document number is more than four,” the following modes can be registered: a first recommended mode #1 includes “combine 2 pages into 1 page with duplex manner” having a priority level 5, a second recommended mode #2 includes “combine 4 pages into 1 page with one sided manner” having a priority level 4, and a third recommended mode #3 includes “combine 2 pages into 1 page with one sided manner” having a priority level 2.

Furthermore, as for the condition of “document color is not white (e.g., blue sheet),” the following modes can be registered: a first recommended mode #1 includes “color sheet mode” having a priority level 5, a second recommended mode #2 includes “white/black copy” having a priority level 1, and a third recommended mode #3 includes “designated color elimination” having a priority level 3.

Based on information in the table shown in FIG. 8A, the touch panel 7e can display a screen view shown in FIG. 8B when a user wants to copy a pile of documents of color sheets having more than four sheets.

The screen view shown in FIG. 8B includes as an example three buttons, corresponding to recommended modes selected from the table shown in FIG. 8A.

For example, three recommended modes having the top three priority levels in the table shown in FIG. 8A can be selected as selection buttons on the screen view shown in FIG. 8B. Such three buttons can be arranged on the screen view (see FIG. 8B) from left to right with an order of priority levels.

Based on the table shown in FIG. 8A, the image forming apparatus FX can display the screen view shown in FIG. 8B when a user wants to copy a pile of documents of color sheets having more than four sheets.

Accordingly, the user can recognize what kind of image processing modes can be conducted by viewing the touch panel 7e, and thereby the image forming apparatus FX can provide a user-friendly functionality, such as time saving, for selecting image processing modes.

Hereinafter, a combined mode that integrates a page combination mode and color sheet mode is explained.

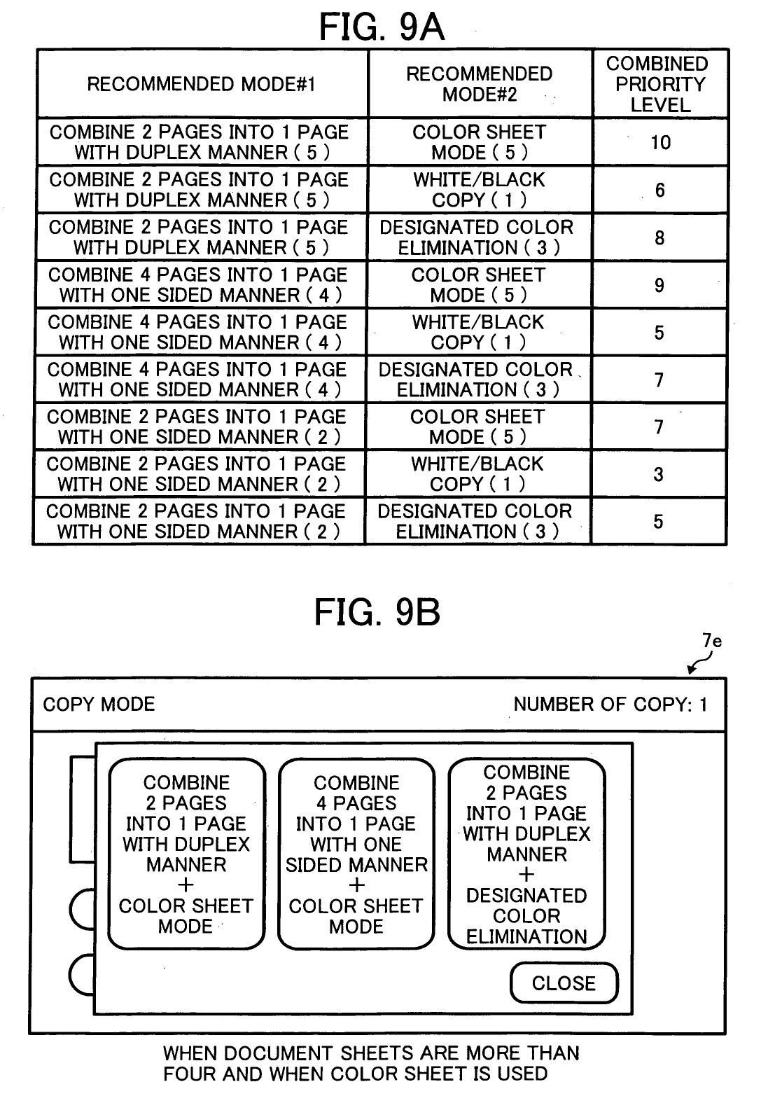

FIG. 9A shows a table including recommended modes and priority levels for the combined mode of the page combination mode and color sheet mode.

The table shown in FIG. 9A includes two recommended modes: a first recommended mode #1 and a second recommended mode #2. The first recommended mode #1 includes modes such as “combine 2 pages into 1 page with duplex manner,” “combine 4 pages into 1 page with one sided manner,” and “combine 2 pages into 1 page with one sided manner,” for example. The second recommended mode #2 includes modes such as “color sheet mode,” “white/black copy,” and “designated color elimination,” for example.

Each mode in the first recommended mode #1 and second recommended mode #2 can be assigned with a priority level as shown in FIG. 9A. The priority level is shown in a parentheses for each mode. A combined priority level can be computed by adding the each priority level of first recommended mode #1 and second recommended mode #2 as shown in FIG. 9A.

Then, a central processing unit (not shown) of the image forming apparatus FX selects three combined modes, for example, wherein each combined mode includes one mode of the first recommended mode #1 and one mode of the second recommended mode #2. Such combined modes can be selected from the table shown in FIG. 9A by referring to the combined priority levels in FIG. 9A.

Based on the table shown in FIG. 9A, the touch panel 7e can display a screen view shown in FIG. 9B including three buttons, corresponding to the three combined modes having the top three combined priority levels in the table shown in FIG. 9A.

For example, such three buttons include a “combine 2 pages into 1 page with duplex manner+color sheet mode” button, a “combine 4 pages into 1 page with one sided manner+color sheet mode” button, and a “combine 2 pages into 1 page with duplex manner+designated color elimination” button. Such three buttons can be arranged on the screen view from left to right as shown in FIG. 9B in an order of priority levels.

Hereinafter, another example screen view of the touch panel 7e is explained.

When the scanner 5 scans a pile of document sheets, the image forming apparatus FX can obtain document attribution information of the scanned document sequentially as the attributed information is detected with a time line.

For example, when a user places a pile of document sheets on a document tray of an automatic document feeder (not shown), the automatic document feeder can detect a document size (e.g., A4) at first. Accordingly, the image forming apparatus FX can detect a document size as a first document attribution information when the pile of document sheets are placed on the automatic document feeder.

Then, the scanner 5 scans document sheets one by one, which are fed from the automatic document feeder. By sensing the scanned image data, the image forming apparatus FX can obtain characteristics of a scanned image (e.g., background color of a document sheet, image color, character/photo information of document sheets) as a second document attribution information.

When the automatic document feeder completes feeding of document sheets and the scanner 5 completes scanning of document sheets, the image forming apparatus FX can obtain information of a number of document sheets piled on the document tray of the automatic document feeder as a third document attribution information.

Accordingly, the image forming apparatus FX can obtain the first to third document attribution information (e.g., document size, characteristics of scanned image, number of document sheets) sequentially in time or with a time-line.

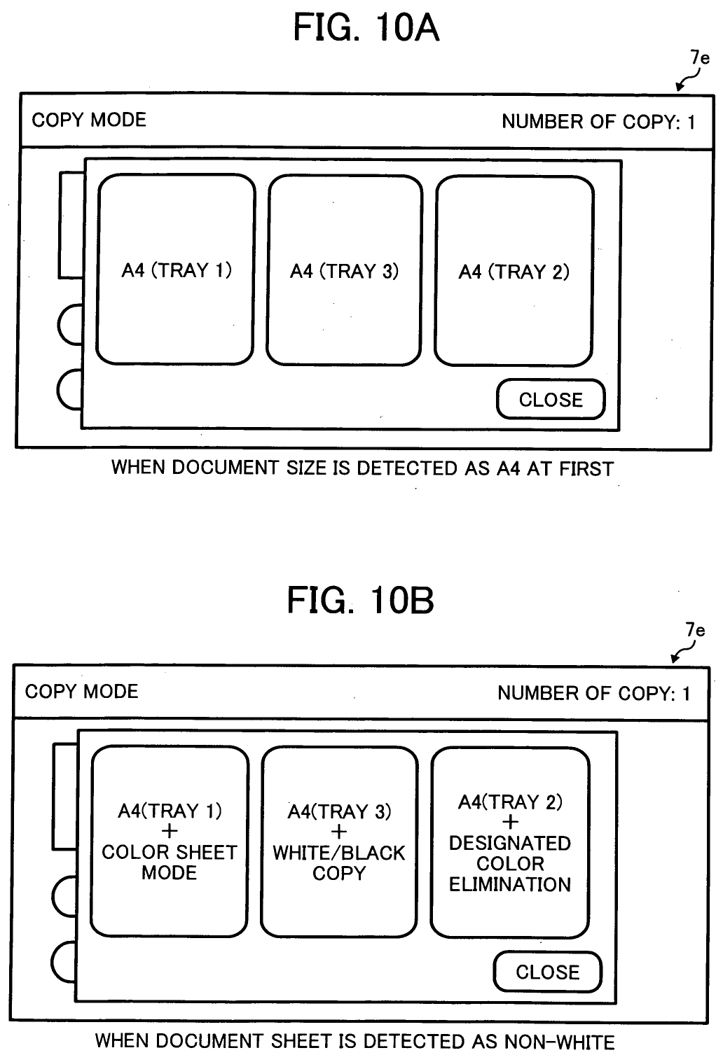

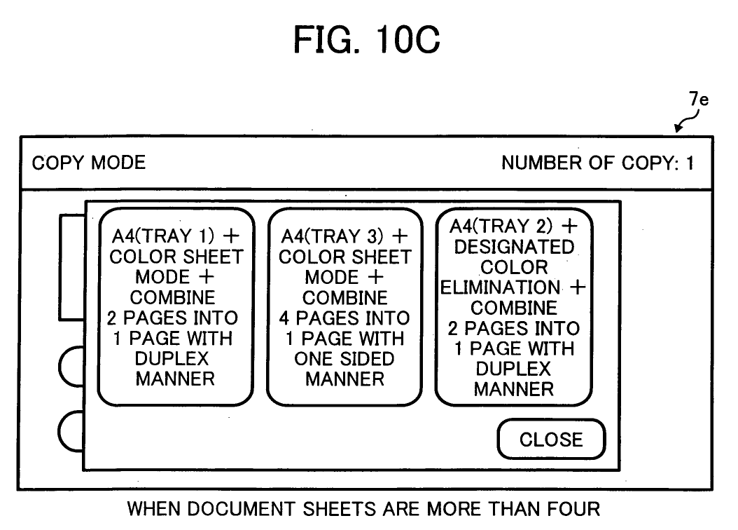

Therefore, the touch panel 7e can display a first screen view shown in FIG. 10A when the image forming apparatus FX obtains a document size (e.g., A4 size), then can display a second screen view shown in FIG. 10B when the image forming apparatus FX obtains characteristics of a scanned image (e.g., document sheet is not white), and can display a third screen view shown in FIG. 10C when the image forming apparatus FX obtains the number of document sheets.

Similarly to other example screen views of the touch panel 7e described above, recommended modes and priority levels for document attribution information shown in FIGS. 10A to 10C can be registered in a table (not shown) in advance.

In this example shown in FIGS. 10A to 10C, the image forming apparatus FX can display screen views for selecting image processing modes to a user step by step (i.e., sequentially in a time line). Specifically, the image forming apparatus FX can switch a screen view of the touch panel 7e at each timing when the image forming apparatus FX obtains each of the first to third document attribution information.

Accordingly, a user can select desired copying conditions step by step (i.e., sequentially in a time line), in which the user can take advantage of a relatively longer time for selecting copying conditions, and thereby the image forming apparatus FX can typically suppress erroneous-operations of the user when the user selects copying conditions.

In the above-described example screen views, image processing modes are displayed as a “pop-up type” view, by which one or more image processing modes that may be suitable for processing a document is selected and displayed on the touch screen 7e. In the case of a “pop-up type” view, a selection of the image processing modes are not set in advance, but the selection of the image processing modes is determined for each case of image forming operations.

Hereinafter, another example screen view of the touch panel 7e, which employs a wizard type, is explained.

The image forming apparatus FX can also provide another display type, which is referred to as a “wizard type,” in which a plurality of image processing modes are categorized in a plurality of layers (e.g., first layer, second layer) in a predetermined order in advance. Each layer may include one or more image processing modes.

Accordingly, the image forming apparatus FX can display and switch a screen view for the plurality of image processing modes categorized in the plurality of layers with the predetermined order on the touch panel 7e (e.g., from first to last layer).

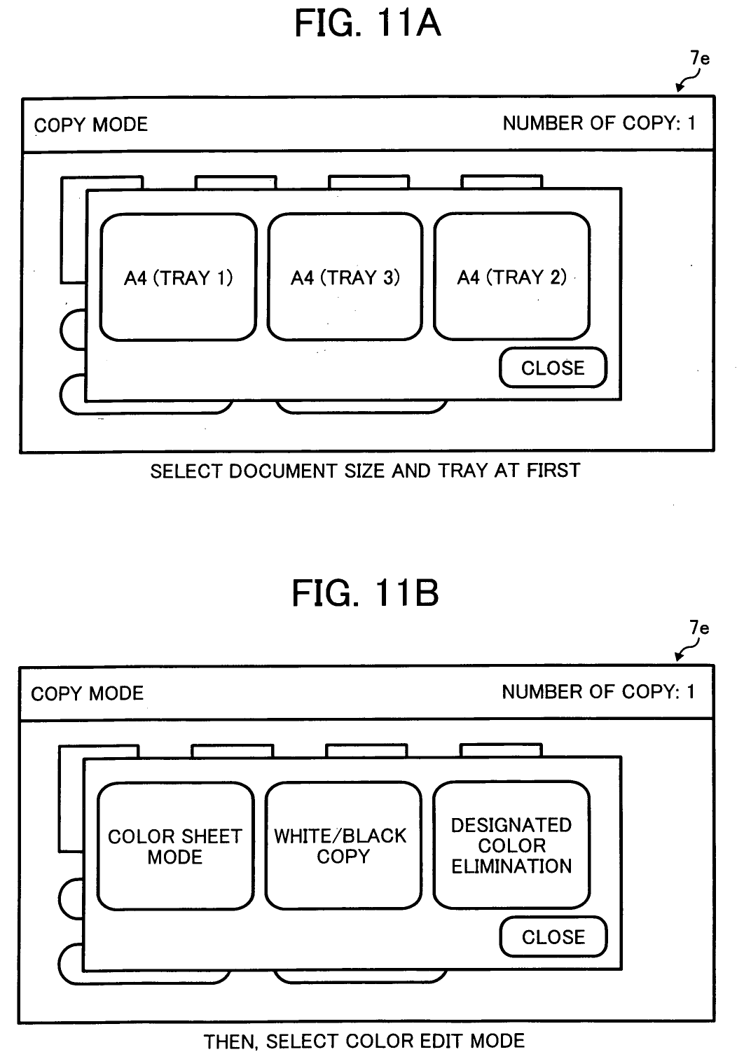

For example, the touch panel 7e may firstly display a screen view shown in FIG. 11A, which shows a sheet size and sheet tray. Then, the touch panel 7e may secondly display a screen view shown in FIG. 11B, which shows a color edit mode. And then, the touch panel 7e may thirdly display a screen view shown in FIG. 11 C, which shows a page mode for combining pages.

Accordingly, by employing the wizard type for selecting image processing modes, a user can conduct operations required for image forming (e.g., copying) without missing the operations.

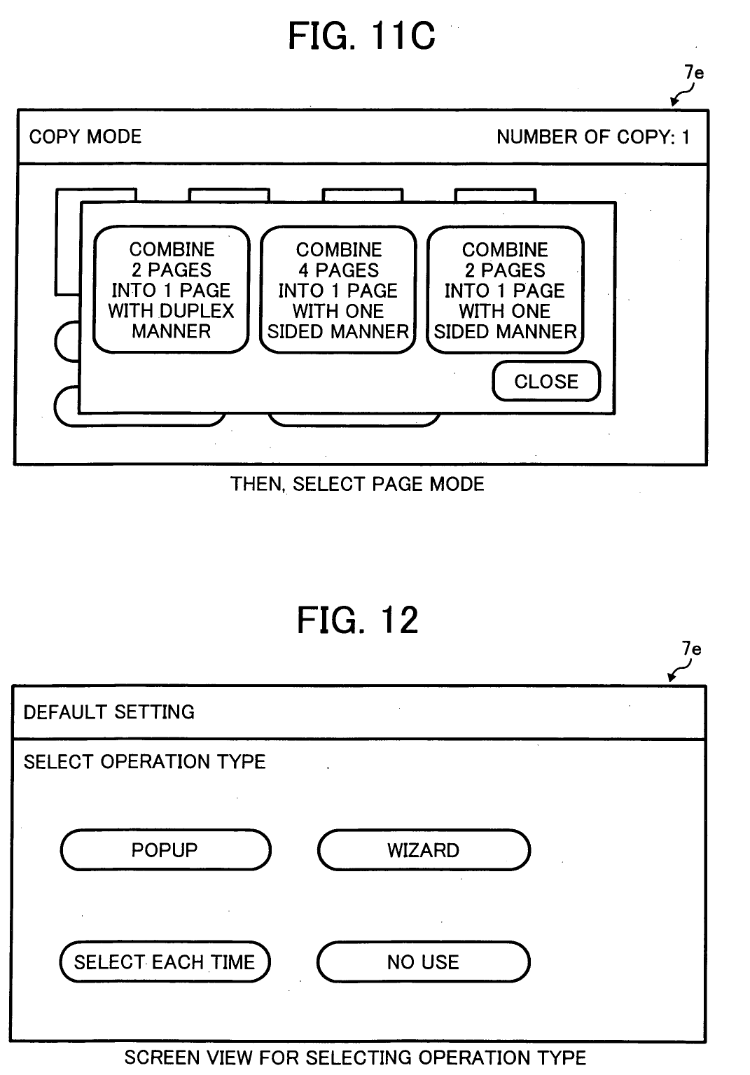

Furthermore, it may be preferable to provide a screen view as shown in FIG. 12 because a user can select a “pop-up type” view or “wizard type” view from the screen, as required.

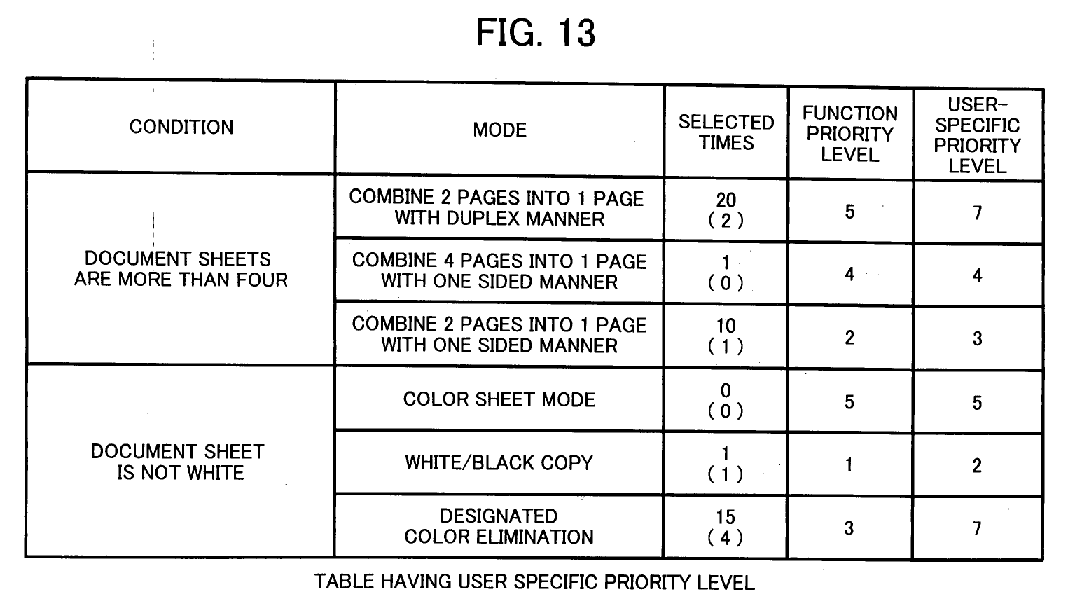

Hereinafter, another example table is explained with reference to FIG. 13.

In this example table shown in FIG. 13, the table can include priority levels designated by a user. Specifically, the image forming apparatus FX can store history information, which includes how many times (i.e., number of times) a user selected each mode in past operations. The image forming apparatus FX may set a priority level for each mode based on that number of times selected by the user. Such history information is referred to as user history information hereinafter.

For example, a condition of “number of document sheets are more than four” includes three modes: “combine 2 pages into 1 page with duplex manner”; “combine 4 pages into 1 page with one sided manner”; and “combine 2 pages into 1 page with one sided manner.”

For example, in previous image forming operations, a user might have selected “combine 2 pages into 1 page with duplex manner,” “combine 4 pages into 1 page with one sided manner,” and “combine 2 pages into 1 page with one sided manner” for 20 times, 1 time, and 10 times, respectively, and thereby the each mode is assigned with priority levels of 2, 0, and 1 respectively as shown in FIG. 13. The priority level for “selected times” is shown in parentheses.

As shown in FIG. 13, each of “combine 2 pages into 1 page with duplex manner,” “combine 4 pages into 1 page with one sided manner,” and “combine 2 pages into 1 page with one sided manner” also includes a function priority level of 5, 4, and 2, respectively, and thereby a user-specific priority level for each mode becomes 7, 4, and 3, respectively, by adding the priority levels of “selected times” and function priority levels shown in FIG. 13.

Accordingly, priority levels for each mode can be adjusted to user-specific priority levels based on the user history information, by which the image forming apparatus FX can provide an improved user-friendly functionality for selecting image processing modes.

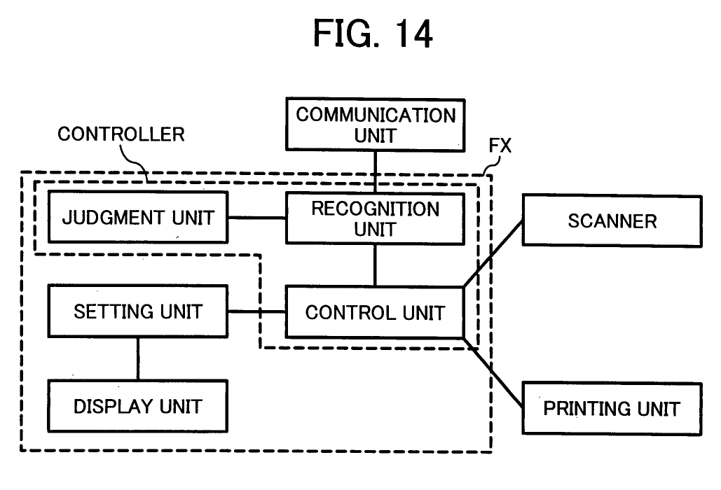

As above-mentioned, the image forming apparatus FX connected to a network system has a configuration as shown in FIGS. 1 and 2. Such a configuration can be schematically illustrated as shown in FIG. 14.

As shown in FIG. 14, the image forming apparatus FX includes a controller, a display unit, and a setting unit. The setting unit can be used to set an operation condition such as image processing modes, and the display unit can display information related to the operation condition such as image processing modes. The image forming apparatus FX may further include a scanner and a printing unit, for example.

The image forming apparatus FX may be connected to a communication unit, as required, to communicate data with other apparatuses connected to the communication unit via a network system such as LAN and Internet.

The controller includes a control unit, a recognition unit, and a judgment unit, as shown in FIG. 14. The controller controls operations in the image forming apparatus FX as a whole.

With the configuration shown in FIG. 14, the image forming apparatus FX can execute a process for setting a recommended mode for a document to be processed in the image forming apparatus FX as below discussed.

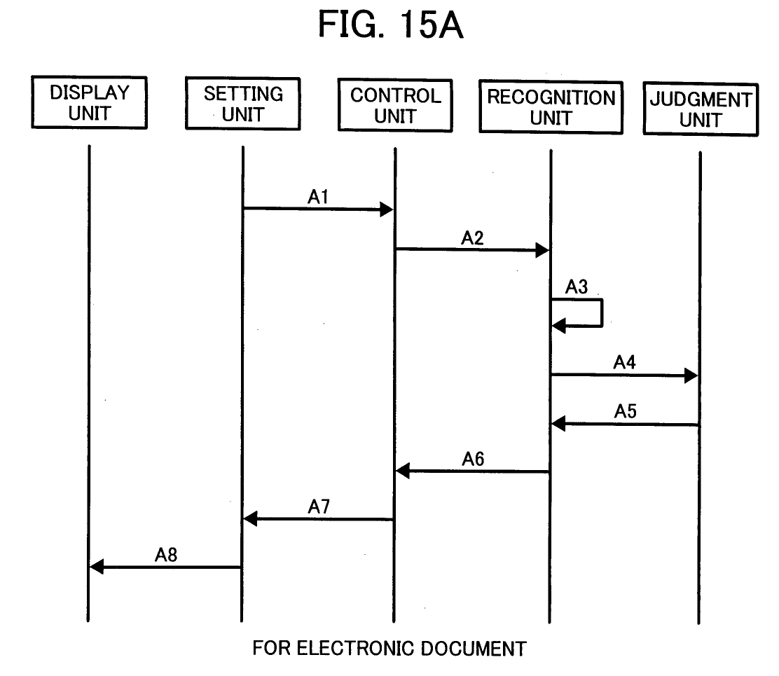

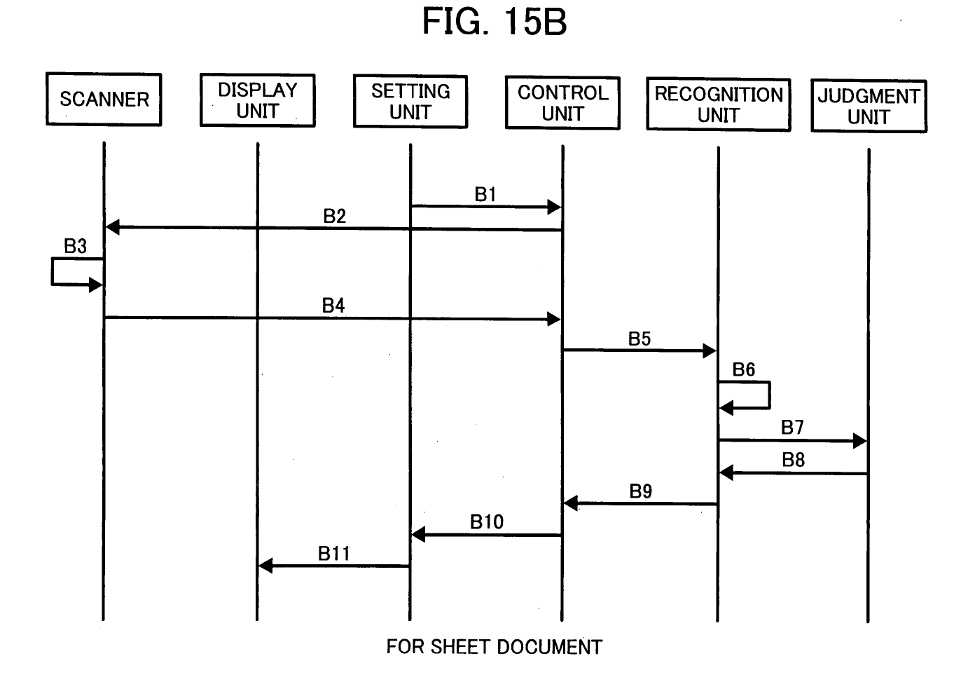

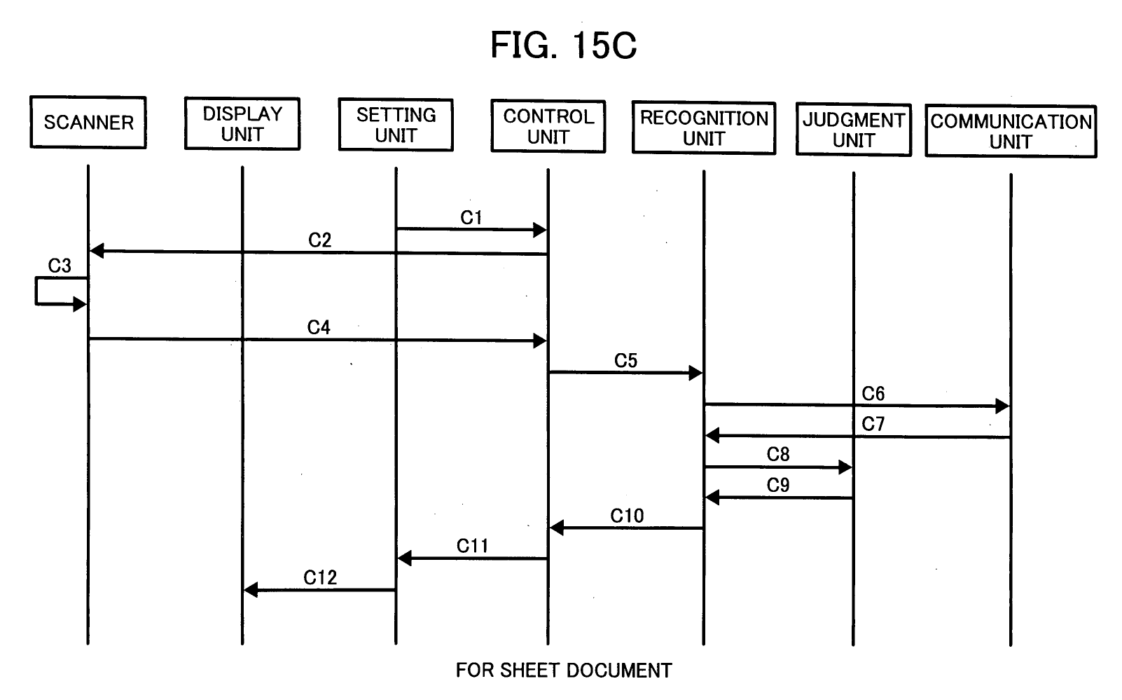

FIGS. 15A to 15C show schematic sequence charts for explaining a process for setting a recommended mode for a document to be processed in the image forming apparatus FX.

FIG. 15A shows a schematic sequence chart for explaining a process for setting a recommended mode for an electronic document with the image forming apparatus FX. The process can be executed as now described below.

At A1, the setting unit designates a document to the control unit.

At A2, the control unit designates the document to the recognition unit.

At A3, the recognition unit obtains document attribution information, which corresponds to the document.

At A4, the recognition unit requests a judgment of a recommended mode for the obtained document attribution information to the judgment unit.

At A5, the judgment unit judges whether a recommended mode exists or not, and informs a result to the recognition unit.

At A6, if the recommended mode is obtained from the judgment unit, the recognition unit requests a display setting to the control unit based on the obtained recommended mode.

At A7, the control unit requests the setting unit to set a screen view matched to the display setting.

At A8, the setting unit requests the display unit to set the screen view, and the display unit displays the screen view.

FIG. 15B shows a schematic sequence chart for explaining a process for setting a recommended mode for a sheet document with the image forming apparatus FX. The process can be executed as now described below.

At B1, the setting unit requests the control unit to command a document scanning instruction.

At B2, the control unit commands the scanner to start a scanning of documents.

At B3, the scanner scans the documents.

At B4, the scanner transmits scanned image data of the documents to the control unit.

At B5, the control unit designates the document to the recognition unit based on the scanned image data.

At B6, the recognition unit obtains document attribution information corresponding to the scanned image data.

At B7, the recognition unit requests a judgment of a recommended mode for the obtained document attribution information to the judgment unit.

At B8, the judgment unit judges whether a recommended mode exists or not, and informs a result to the recognition unit.

At B9, if the recommended mode is obtained from the judgment unit, the recognition unit requests a display setting to the control unit based on the recommended mode.

At B10, the control unit requests the setting unit to set a screen view matched to the display setting.

At B11, the setting unit requests the display unit to set the screen view, and the display unit displays the screen view.

FIG. 15C shows a schematic sequence chart for explaining a process for setting a recommended mode for a sheet document with the image forming apparatus FX, wherein document attribution information is obtained from a server connected to the image forming apparatus FX via the communication unit. The process can be executed as now described below.

At C1, the setting unit requests the control unit to command a document scanning instruction.

At C2, the control unit commands the scanner to start a scanning of documents.

At C3, the scanner scans the documents.

At C4, the scanner transmits scanned image data of the documents to the control unit.

At C5, the control unit designates the document to the recognition unit based on the scanned image data.

At C6, the recognition unit requests the communication unit to obtain document attribution information by designating identification (ID) information of the scanned image data.

At C7, the communication unit obtains the document attribution information corresponding to the ID information from a server (not shown) connected to the communication unit, and the communication unit returns the document attribution information to the recognition unit.

At C8, the recognition unit requests a judgment of the recommended mode for the obtained document attribution information to the judgment unit.

At C9, the judgment unit judges whether a recommended mode exists or not, and informs a result to the recognition unit.

At C10, if the recommended mode is obtained from the judgment unit, the recognition unit requests a display setting to the control unit based on the recommended mode.

At C11, the control unit requests the setting unit to set a screen view matched to the display setting.

At C13, the setting unit requests the display unit to set the screen view, and the display unit displays the screen view.

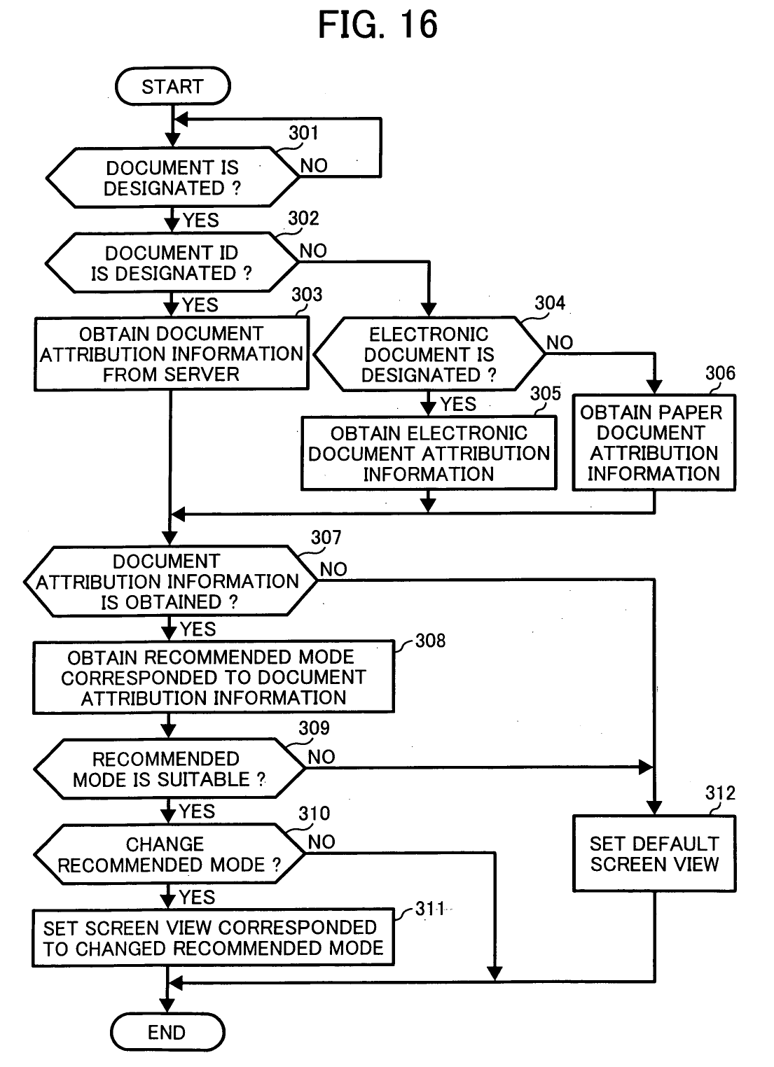

FIG. 16 is a flow chart explaining a process for setting a recommended mode for a document to be processed in the image forming apparatus FX connected to a network system.

In step 301, the controller of the image forming apparatus FX judges whether a user designates a document.

If the controller judges that the document is designated (Yes in 301), the controller checks whether a document ID (identification) is designated in step 302.

If the controller judges that the document ID is designated in step 302 (Yes in 302), the controller requests document attribution information, corresponding to the document ID, to the server SM via the LAN, and obtains the document attribution information from the server SM in step 303.

If the controller judges that the document ID is not designated in step 302 (No in 302), the controller checks whether an electronic document is designated in step 304.

If the controller judges that an electronic document is designated in the step 304 (Yes in 304), the controller obtains the electronic document attribution information in step 305.

If the controller judges that an electronic document is not designated in the step 304 (No in 304), the controller obtains document attribution information for a paper document in step 306.

In step 307, the controller checks whether the document attribution information is obtained.

If the controller confirms that the document attribution information is obtained in step 307 (Yes in 307), the controller obtains a recommended mode, which corresponds to the document attribution information, in step 308.

In step 309, the controller checks whether the obtained recommended mode is suitable for the document.

If the controller confirms that the obtained recommended mode is suitable for the document in step 309 (Yes in 309), the controller checks whether a recommended mode is changed in step 310.

If the controller confirms that a recommended mode is changed in step 310 (Yes in 310), the controller selects a screen view, corresponding to the changed recommended mode in step 311.

If the controller confirms that a recommended mode is not changed in step 310 (No in 310), the process is completed by skipping the step 311.

If the controller confirms that document attribution information is not obtained in step 307 (No in 307), or if the controller confirms that the recommended mode is not suitable for the document in step 309 (No in 309), the controller sets a default screen view on the touch panel 7e in step 312.

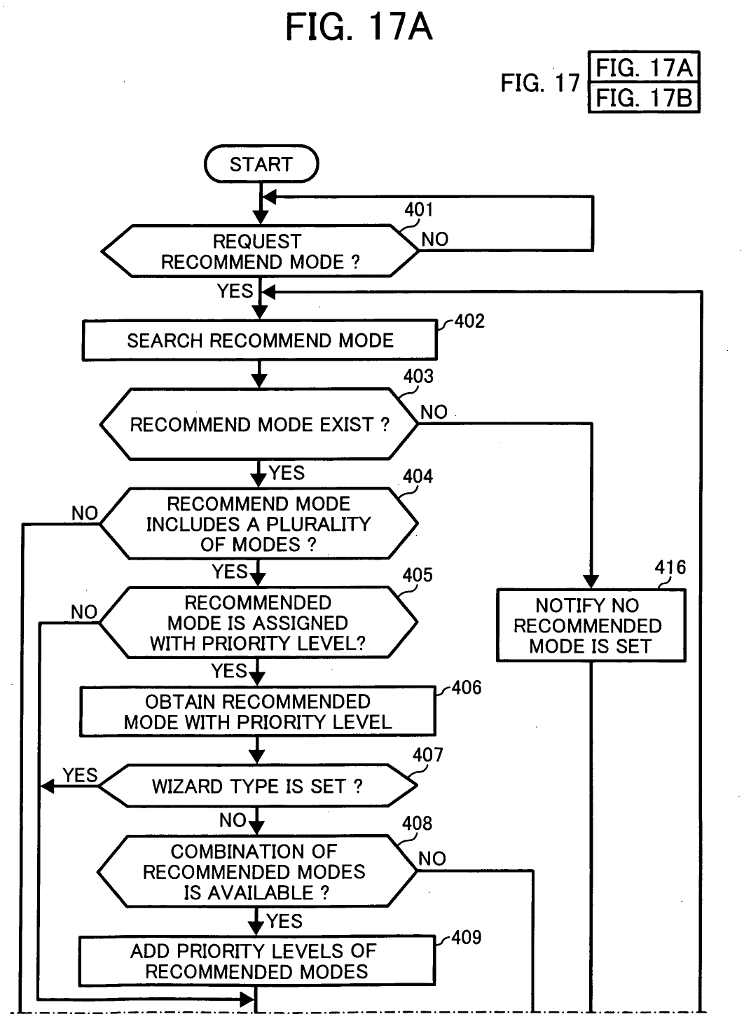

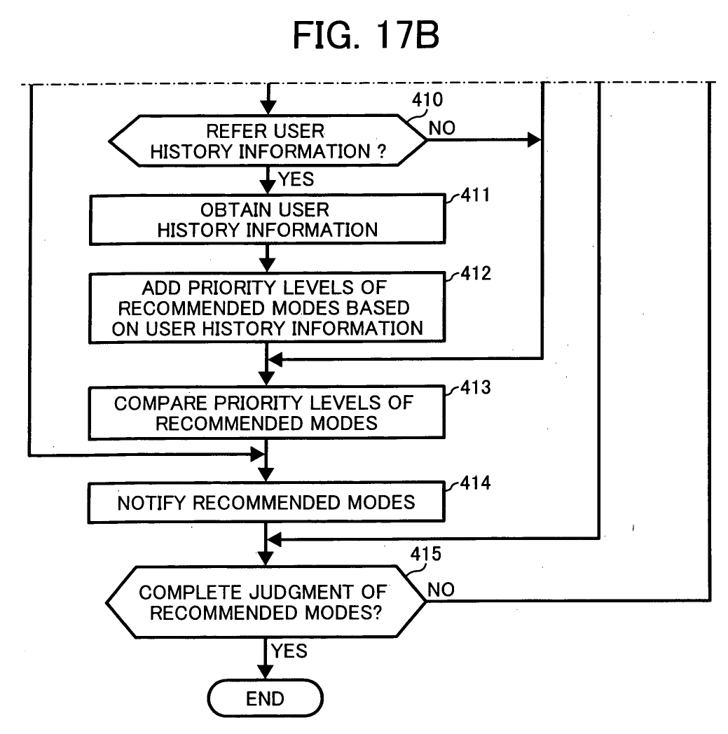

FIGS. 17A, 17B are a flow chart for explaining the above-mentioned step 308 in detail.

In step 401, the recognition unit of the controller requests a recommended mode to the judgment unit of the controller.

In step 402, the judgment unit refers to a table having recommended modes.

In step 403, the judgment unit checks whether a recommended mode, which corresponds to the document attribution information, exists or not. If the judgment unit confirms that the recommended mode corresponding to the document attribution information exists in step 403 (Yes in 403), the judgment unit checks whether a plurality of recommended modes exists in step 404.

If the judgment unit confirms that the plurality of recommended modes exists in step 404 (Yes in 404), the judgment unit checks whether the plurality of recommended modes are assigned with priority levels in step 405.

If the judgment unit confirms that the plurality of recommended modes are assigned with priority levels in step 405 (Yes in 405), the judgment unit obtains priority levels for the plurality of recommended modes in step 406.

In step 407, the judgment unit checks whether a wizard type, which can select recommended modes with a predetermined order, is set or not. If the judgment unit confirms that the wizard type is not set in step 407 (No in 407), the judgment unit checks whether a combination of recommended modes is available in step 408.

If the judgment unit confirms that the combination of recommended modes is available in step 408 (Yes in 408), the judgment unit adds priority levels of the recommended modes in step 409.

In step 410, the judgment unit checks whether user history information is referred to or not. If the judgment unit confirms that the user history information is referred to in step 410 (Yes in 410), the judgment unit obtains the user history information in step 411.

In step 412, the judgment unit adds priority levels of the recommended modes based on the user history information.

In step 413, the judgment unit compares priority levels of the recommended modes to select modes having greater priority levels compared to other modes, and uses such selected recommended modes having greater priority levels for the designated document.

In step 414, the judgment unit notifies the selected recommended modes to the recognition unit of the controller.

In step 415, the judgment unit checks whether a judgment of the recommended modes is completed. If the judgment unit confirms that the judgment of the recommended modes is not completed in step 415 (No in 415), the process goes back to step 402, and subsequent steps are executed again.

Furthermore, if the judgment unit confirms that a recommended mode corresponded to the document attribution information does not exist in step 403 (No in 403), the judgment unit notifies the recognition unit that no recommended mode is set in step 416, and then the process goes to step 415, and subsequent steps are executed.

Furthermore, if the judgment unit confirms that a plurality of recommended modes is not included in step 404 (No in 404), the process goes to step 414, and subsequent steps are executed.

Furthermore, if the judgment unit confirms that recommended modes are not assigned with priority levels in step 405 (No in 405), or if the judgment unit confirms that a wizard type is set in step 407 (Yes in 407), the process goes to step 410, and subsequent steps are executed.

Furthermore, if the judgment unit confirms that a combination of recommended modes is not available in step 408 (No in 408), or if the judgment unit confirms that user history information is not referred in step 410 (No in 410), the process goes to step 413, and subsequent steps are executed.

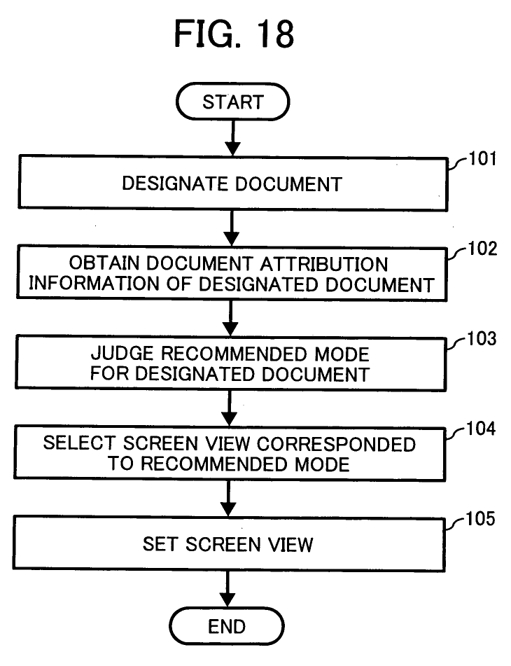

FIG. 18 is an example flow chart explaining a process for setting a recommended mode for a document.

In step 101, a user designates an electronic document to be processed in the image forming apparatus FX.

In step 102, the controller obtains document attribution information corresponding to a document ID (identification) of the electronic document.

If the document attribution information corresponding to the document ID is stored in a memory unit of the image forming apparatus FX in advance, the controller of the image forming apparatus FX can retrieve the document attribution information from the memory unit.

If the document attribution information corresponding to the document ID is not stored in a memory unit of the image forming apparatus FX, the controller can request the document attribution information to the server SM via the LAN. When the server SM receives such a request, the server SM retrieves the document attribution information from a database (not shown) of the server SM, and transmits the document attribution information to the controller of the image forming apparatus FX. Accordingly, the controller can obtain document attribution information of the designated document.

In step 103, the controller judges a recommended mode for the designated document based on the document attribution information.

In step 104, a screen view corresponding to the recommended mode is selected.

In step 105, the selected screen view is set on the touch panel 7e.

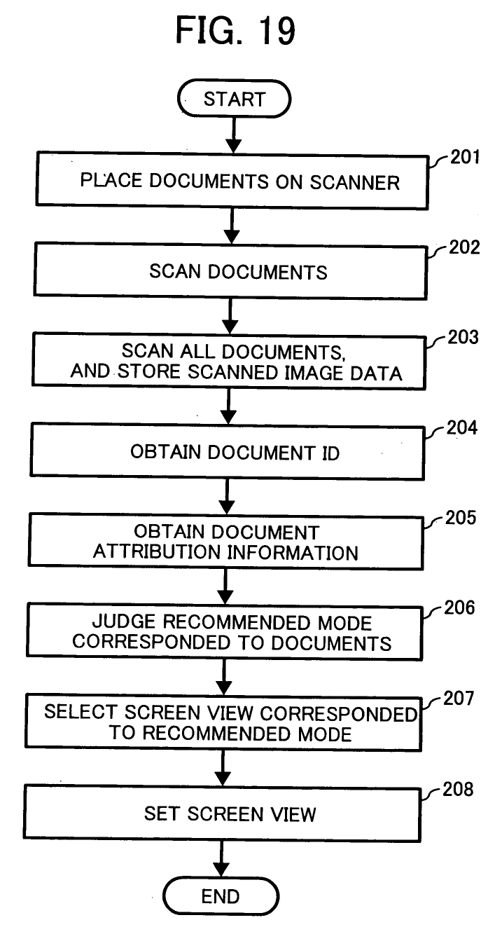

FIG. 19 is another example flow chart explaining a process for setting a recommended mode for a sheet document.

In step 201, a user places a pile of document sheets on an automatic document feeder (not shown).

In step 202, the scanner 5 scans the document sheets fed from the automatic document feeder.

In step 203, the scanner 5 completes scanning of document sheets, and scanned image data are stored in the magnetic disk unit 9.

In step 204, the controller obtains a document ID corresponding to the document.

In step 205, the controller obtains document attribution information of the document similarly as in the above-explained step 102.

In step 206, the controller judges a recommended mode corresponding to the document attribution information of the document.

In step 207, a screen view corresponding to the recommended mode is selected.

In step 208, the selected screen view is set on the touch panel 7e.

In the above-described example embodiment, the image forming apparatus FX is connected to a network system. However, the above-described example embodiment can be used for an image forming apparatus FX of stand-alone type, which is not connected to a network system.

Furthermore, in the above-described example embodiment, the document may include an encoded mark on the document such as a bar code and image code, for example. By decoding the encoded mark such as a bar code, the document attribution information of the document can be obtained.

The encoded mark such as a bar code can be printed (or attached) on a document sheet, and document attribution information of the document sheet is obtained by decoding the encoded mark such as a bar code when the document sheet is scanned by a scanner of the image forming apparatus.

Furthermore, the document attribution information obtained by decoding the encoded mark such as a bar code can be obtained from any one of a memory unit in the image forming apparatus and another apparatus connected to the image forming apparatus, wherein the another apparatus can be connected to the image forming apparatus via a LAN, the Internet, etc.

Furthermore, the encoded mark also includes an electronically encoded mark embedded in an electronic document, and document attribution information can be obtained by decoding the electronically encoded mark when the electronic document is designated in the image forming apparatus.

Furthermore, the document attribution information obtained by decoding the electronically encoded mark can be obtained from any one of a memory unit in the image forming apparatus and another apparatus connected to the image forming apparatus, wherein the another apparatus can be connected to the image forming apparatus via a LAN, the Internet, etc.

Numerous additional modifications and variations are possible in light of the above teachings. It is therefore to be understood that within the scope of the appended claims, the disclosure of the present invention may be practiced otherwise than as specifically described herein.

This application claims priority from Japanese patent application No. 2005-139336 filed on May 12, 2005 in the Japan Patent Office, the entire contents of which are hereby incorporated by reference herein.

1. An image forming apparatus for processing a document with document attribution information, the image forming apparatus comprising:
a controller configured to set an image processing mode, which matches to the document attribution information of the document, when the document to be processed by the image forming apparatus is designated; and
a display unit configured to display the image processing mode as a screen view, by which an operator selects the image processing mode.

2. The image forming apparatus according to claim 1, wherein the controller comprises:
a control unit configured to designate a document;
a recognition unit configured to obtain document attribution information for the document designated by the control unit; and
a judgment unit configured to judge an image processing mode based on the document attribution information obtained by the recognition unit, and to transmit information of the judged image processing mode to the control unit via the recognition unit.

3. The image forming apparatus according to claim 1, wherein the document attribution information is input to the image forming apparatus when a document is scanned by a scanner of the image forming apparatus.

4. The image forming apparatus according to claim 1, wherein the document attribution information is stored in a memory unit of the image forming apparatus.

5. The image forming apparatus according to claim 1, wherein the document attribution information is received by the image forming apparatus from another apparatus connected to the image forming apparatus via a communication unit.

6. The image forming apparatus according to claim 1, wherein the document attribution information is specified by identification information attached to a document.

7. The image forming apparatus according to claim 6, wherein the identification information is stored in a tag attached to the document, the tag includes an integrated circuit to store the identification information, and wherein the controller uses the identification information in the tag to retrieve document attribution information of the document from another apparatus connected to the image forming apparatus via a communication unit.

8. The image forming apparatus according to claim 1, wherein the document includes an encoded mark on the document, and document attribution information of the document is obtained by decoding the encoded mark.

9. The image forming apparatus according to claim 8, wherein the encoded mark includes a printed code attached on a document sheet, and document attribution information of the document sheet is obtained by decoding the printed code when the document sheet is scanned by a scanner of the image forming apparatus.

10. The image forming apparatus according to claim 9, wherein the document attribution information obtained by decoding the printed code is obtained from either one of a memory unit in the image forming apparatus or another apparatus connected to the image forming apparatus.

11. The image forming apparatus according to claim 8, wherein the encoded mark includes an electronically encoded mark embedded in an electronic document, and document attribution information is obtained by decoding the electronically encoded mark when the electronic document is designated in the image forming apparatus.

12. The image forming apparatus according to claim 11, wherein the document attribution information obtained by decoding the electronically encoded mark is obtained from either one of a memory unit in the image forming apparatus or another apparatus connected to the image forming apparatus.

13. A method of controlling a screen view of a display unit of an image forming apparatus for document processing, the method comprising:
designating a document;
obtaining document attribution information of the document;
requesting an image processing mode matched to the document attribution information of the document;
judging the image processing mode matched to the document attribution information;
setting a screen view corresponding to the image processing mode; and
displaying the screen view on the display unit.

14. The method according to claim 13, wherein the document includes either one of a document sheet or an electronic document.

15. The method according to claim 13, wherein the image forming apparatus includes a memory unit that stores a plurality of image processing modes.

16. The method according to claim 15, wherein an image processing mode matched to the document attribution information is selected from the memory unit in the judging, and the selected image processing mode is displayed as a screen view on the display unit in the displaying.

17. The method according to claim 15, wherein the memory unit further stores a plurality of priority levels corresponding to each of the plurality of image processing modes.

18. The method according to claim 17, wherein an image processing mode matched to the document attribution information is selected from the memory unit by comparing the priority levels of image processing modes in the judging, and the selected image processing mode is displayed as a screen view on the display unit.

19. The method according to claim 15, wherein when the image forming apparatus obtains a plurality of document attribution information one by one sequentially in a time-line manner in the obtaining, image processing modes, respectively corresponding to each of the plurality of document attribution information obtained with the time-line manner, are displayed on the display unit one by one sequentially in the time-line manner in the displaying.

20. The method according to claim 15, wherein the plurality of image processing modes, corresponding to a plurality of document attribution information, are classified in a first layer of image processing modes and a second layer of image processing modes in advance, and wherein the first layer of image processing modes is firstly displayed on the displaying unit, and then the second layer of image processing modes is secondly displayed on the displaying unit in the displaying.

21. The method according to claim 17, wherein the priority levels are adjustable by referring to user history information, which includes a frequency of selecting each image processing mode in previous image processing operations.

22. The method according to claim 13, wherein the document attribution information is obtained from another apparatus connected to the image forming apparatus in the obtaining.

23. The method according to claim 22, wherein the another apparatus is connected to the image forming apparatus via a network system, and wherein the network system includes either one of a local area network or a web-based network.

24. A program comprising computer-readable instructions that, when executed by a computer of an image forming apparatus, instructs the image forming apparatus to carry out a method of controlling a screen view of a display unit of the image forming apparatus, the computer-readable instructions comprising:
designating a document;
obtaining document attribution information of the document;
requesting an image processing mode matched to the document attribution information of the document;
judging the image processing mode matched to the document attribution information;
setting a screen view corresponding to the image processing mode; and
displaying the screen view on the display unit.

25. The program according to claim 24, wherein the document includes either one of a document sheet or an electronic document.
